(19) United States
(12) Patent Application Publication
(10) Pub. No.: US 2018/0113918 A1
(43) Pub. Date: Apr. 26, 2018

(54) MICRO PRODUCT SPECIFICATION UPDATE BASED ON RESULTS TO A SEARCH QUERY

(71) Applicant: Twiggle Ltd., Tel-Aviv (IL)

(72) Inventors: Amir KONIGSBERG, Tel-Aviv (IL); Adi AVIDOR, Tel-Aviv (IL); Yuval BAHARAV, Herzlia Pituach (IL)

(21) Appl. No.: 15/298,264

(22) Filed: Oct. 20, 2016

(51) Int. Cl. G06F 17/30; G06F 3/0482; G06F 9/44

(52) U.S. Cl. CPC G06F 17/30554; G06F 9/4443; G06F 17/3053; G06F 3/0482

(57) ABSTRACT

A system and method for controlling a graphical user interface (GUI) configured for searching in a database and for changing dynamically based on a received search query, the method including maintaining a database indexed according to attributes defined in a database model interpreting a received search query term by a natural language analyzer as at least one of the attributes extracting from the indexed database search results having values of the at least one of the attributes, and adapting design elements of the GUI to display statistical information about the used at least one attribute and the attribute values.

### BACKGROUND

The present invention, in some embodiments thereof, relates to a graphical user interface associated with a search engine for performing a database search and, more specifically, but not exclusively, to a graphical user interface enabling an enhanced dynamic presentation of search results.

During a database search, users frequently revise the search query in order to receive search results that may match better their needs or in order to reduce the number of results.

### SUMMARY

According to an aspect of some embodiments of the present invention there is provided a system for controlling a graphical user interface (GUI) configured for searching in a database and for changing dynamically based on a received search query, the system including a memory storing a code, and at least one hardware processor coupled to the memory for executing said code, the code including instructions for maintaining a database indexed according to attributes defined in a database model, instructions for interpreting a received search query term by a natural language analyzer as at least one of the attributes, instructions for extracting from the indexed database search results having values of the at least one of the attributes, and instructions for adapting design elements of the GUI to display statistical information about the used at least one attribute and the attribute values.

Optionally, the code includes instructions for using the at least one of the attributes as a sorting parameter for use by the search server for sorting query results.

Optionally, the code includes instructions for interpreting a received search query term as at least one of a category, an attribute or an attribute value of the database model.

Optionally, the code includes instructions for using the at least one of the attributes as a filtering parameter for filtering out search results with values that cross a predefined threshold.

Optionally, the code includes instructions for obtaining from the indexed database information about at least one of a category, attribute and value of each search result, based on the interpretation of the search term.

Optionally, the code includes instructions for updating the design of the GUI to present in the vicinity of each search result the obtained information.

Optionally, the code includes instructions for updating the design of the GUI to present the search results in an order according to ranking scores assigned to each search result according to a value of the at least one of the attributes.

Optionally, adapting design elements of the GUI is to display ranking of the search results according to values of the at least one of the attributes.

Optionally, the statistical information includes a size of a group of items included in the search results relative to a size of the indexed database and a size of a specific category of the indexed database.

Optionally, the code includes instructions for identifying filters applied by the search server.

Optionally, the code includes instructions for updating the design of the GUI by adapting to the search results predefined designed elements stored in a design database and adding the adapted elements to the GUI.

Optionally, the code includes instructions for updating the design of the GUI in real time upon a change in the search query or in pre-determined time periods.

Optionally, the code includes instructions for updating the design of the GUI by changing in response to a change in the search query at least one of an order the search results, information accompanying the search results, or a graphical element representing the group of items included in the search results.

Optionally, the graphical element includes at least one representative graphic sub-element representing a size of a group of search results relative to a size of another group of search results.

Optionally, the graphical element includes at least two representative graphic sub-element having shapes of different sizes, the smaller shapes are contained in the larger shapes, representing sizes of respective groups of items.

Optionally, each of representative graphic sub-elements includes one or more units, wherein the number of units represents the number of items in the represented group.

According to an aspect of some embodiments of the present invention there is provided a method for controlling a graphical user interface (GUI) configured for searching in a database and for changing dynamically based on a received search query, the method including maintaining a database indexed according to attributes defined in a database model, interpreting a received search query term by a natural language analyzer as at least one of the attributes, extracting from the indexed database search results having values of the at least one of the attributes, and adapting design elements of the GUI to display statistical information about the used at least one attribute and the attribute values.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic flowchart illustrating a method for dynamic presentation of search results, according to some embodiments of the present invention;

FIG. 2 is a schematic illustration of a system for dynamic presentation of search results, according to some embodiments of the present invention;

FIGS. 3A and 3B are schematic illustrations of a portion of a dynamically changing graphical user interface (GUI), according to some embodiments of the present invention;

FIG. 4 is a schematic illustration of another exemplary design of a GUI, according to some embodiments of the present invention;

FIG. 5 is a schematic illustration of a portion of another exemplary dynamically changing GUI, according to some embodiments of the present invention; and

FIG. 6 is a schematic illustration of a portion of another exemplary dynamically changing GUI, according to some embodiments of the present invention.

### DETAILED DESCRIPTION

Some embodiments of the present invention provide a dynamically changing graphical user interface (GUI) for search query input and for presentation of search results, which changes dynamically in response to a changing search query.

In some embodiments of the present invention, design elements of the GUI may be adapted to display statistical information about attributes and attribute values used for obtaining search result. For example, a database is maintained, indexed according to attributes defined in a database model. A received search query term is interpreted by a natural language analyzer (NLA) as one of the defined attributes, identified by the NLA as matching the search query term. The identified attribute is used by a search server to extract from the indexed database search results having values of the identified attribute, according to which the GUI is updated.

In accordance to some embodiments of the present invention, the GUI graphically presents to a user, in response to a changing search query, a dynamically changing size of a group of search results. Accordingly, when the size of the group of items that match a search query changes as result of adding and/or removing search terms from the query, this change is graphically presented to the user in real time.

In accordance to some embodiments of the present invention, the GUI presents to a user contextual data related to his query in real-time. For example, the GUI dynamically changes the selection of which items are presented to a user in the results page, according to terms inputted to a search query field, which are interpreted by a natural language analyzer (NLA) as filtering and/or sorting criteria that are applied by a search server on the target database. Moreover, the GUI displays in the vicinity of each presented item contextual data relevant to inputted search terms, for example corresponding values of attributes included in the search query.

According to some embodiments of the present invention, a technical solution is provided for an enhanced dynamic presentation of search results. The system includes a search interface server that controls the GUI, a search interpretation server, and a search server that extract the search results from a database. The presentation of the search results changes dynamically according to the terms included in the search query field, which are interpreted by the interpretation server according to a database model and a NLA engine. Thus, the presented information is particularly relevant to the user's needs as reflected by the search query terms, and the provided solution increases the computational and time efficiency of the search process.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service

Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

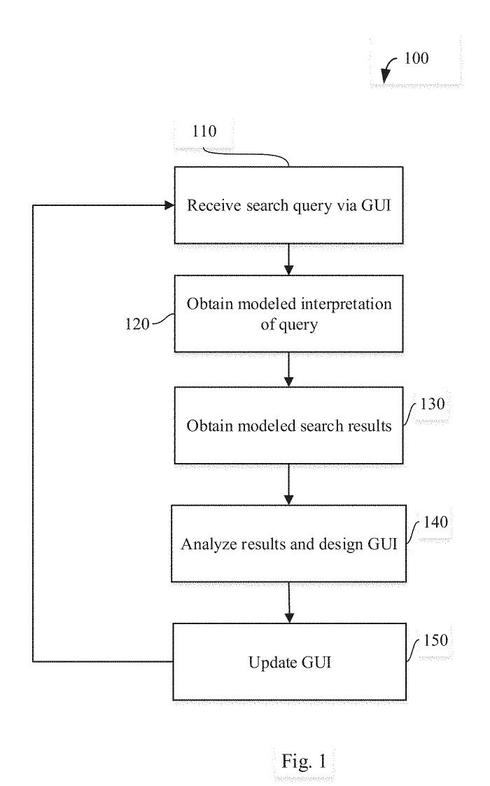

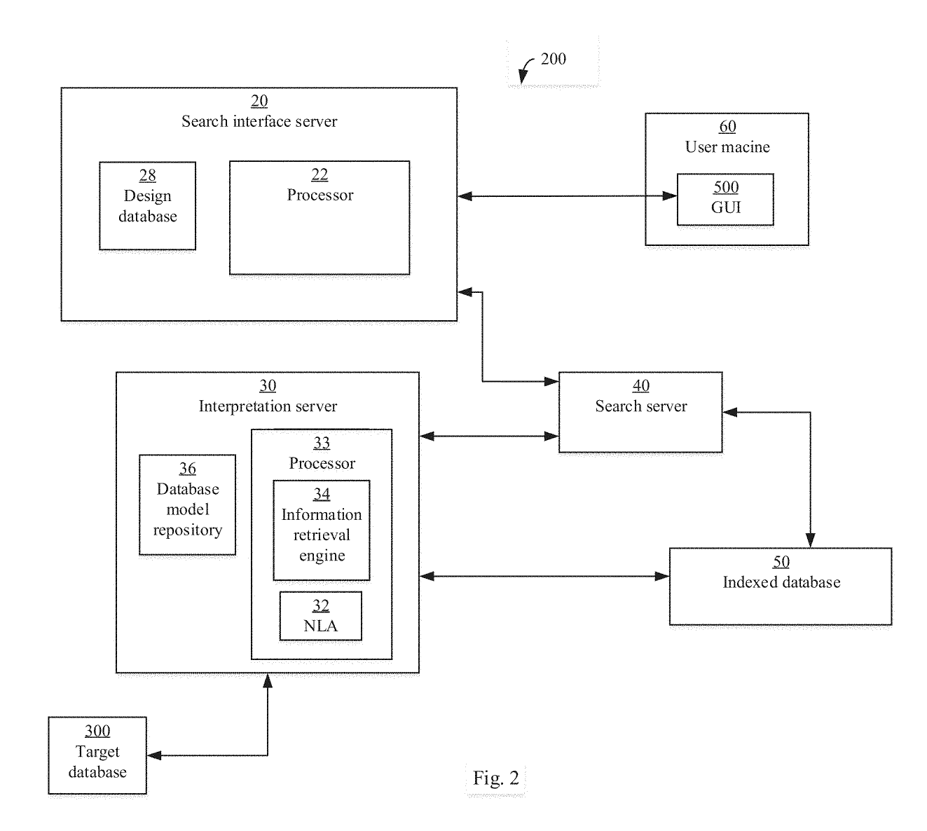

Reference is now made to FIG. 1, which is a schematic flowchart illustrating a method 100 for dynamic presentation of search results, according to some embodiments of the present invention. Further reference is now made to FIG. 2, which is a schematic illustration of a system 200 for dynamic presentation of search results, according to some embodiments of the present invention. System 200 includes a search interface server 20, an interpretation server 30 and a search server 40. Search interface server 20 may control a graphical user interface (GUI) 500.

GUI 500 may be provided to a user for performing a search in a target data source 300. Target data source 300 may be an e-commerce catalogue, website or database of e-commerce items presented in websites, for example products presented for sale. Target data source 300 may include information about each item, such as its price and relevant technical specification details, as well as a category and/or sub-categories to which the item belongs.

As indicated in block 110, search interface server 20 may receive from a user machine 60 a search query, for example via GUI 500 executed on user machine 60. The search query may include, for example, text input and/or other search query data, such as an indication of a specific category and/or a target data source 300. Search interface server 20 may pass the search query to search server 40 for performing a search in a target database 300.

Search interface server 20 may receive search results from search server 40 and/or present the results to a user. In order to present relevant dynamically changing information along with the results, search interface server 20 receives the relevant information from search server 40 along with a result list of relevant items. The dynamically changing information may include, for example, statistical information about the target database and categories to which the listed items belong, and/or information about attributes and values of each of the listed items, for example according to attributes mentioned in the search query or relate to it.

Some embodiments of the present invention provide a database model, which facilitates extraction of relevant dynamically changing information. The database model may be stored in a repository 36 and/or monitored by interpretation server 30. In some embodiments of the present invention, the target searched data source 300 needs to be adapted to the database model by interpretation server 30. Accordingly, interpretation server 30 may create an indexed database 50 by indexing the data included in target searched data source 300 according to the database model.

In indexed database 50, each item of the searched database belongs to certain categories and/or subcategories and has values of attributes related to these categories.

A received search query may be interpreted according to the database model, so that a term included in the query refers to a category, an attribute or a value of the database model. Accordingly, as indicated in block 120, search server 40 may obtain by interpretation server 30 a modeled interpretation of the search query, i.e. interpretation of the search query based on the database model. The interpretation of the search query may include, for example, a representation of the search query by predefined filters and/or parameters of the database model.

In some embodiments of the present invention, interpretation server 30 executes a Natural Language Analyzer (NLA) 32 and an information retrieval engine 34. NLA 32 may find in the database model possible interpretations of terms of the search query. Information retrieval engine 34 may obtain possible interpretations of the search query by NLA 32, and construct a modeled representation of the search query, i.e. representation of the search query by predefined filters and parameters implemented in the database model. An interpretation of the search query may include categories, attributes and/or values defined in the database model, which are identified as a coherent interpretation of the search query elements.

The interpretation of the search query enables search server 40 to perform a modeled search by applying the categories, attributes and/or values of the interpreted query as filters and ranking parameters, and/or to extract information that specifically relates to the corresponding categories, attributes and/or values.

For example, search interface server 20 may receive the query “light laptop” and forward the query to search server 40. NLA 32 may associate, based on definitions embedded in the database model, the term “light” with small values of the attribute “weight” and interpret the query by matching to the query the category “Laptop” of the database model, which has the attribute “weight”. Based on this interpretation of NLA 32, search server 40 may filter the items in indexed database 50 according to the category “laptop” and rank the results according to the weight value of each item in this category, wherein items with smaller weight values receive higher ranking, according to the interpretation of the term “light” by NLA 32.

In some embodiments of the present invention, a search term may be interpreted by NLA 32 as a filtering parameter for filtering out search results with values that cross a predefined threshold. For example, the term “light” may be interpreted by NLA 32 as a filtering parameter for filtering out search results with weight values above a predefined threshold. For example, the term “good ram” may be interpreted as a filtering parameter for filtering out search results with internal memory values below a predefined threshold. Based on the interpretation, search server 40 may filter the “laptop” category items according to the predefined threshold and/or rank the results according to the parameter values.

Accordingly, as indicated in block 130, by applying the modeled representation of the search query on indexed database 50, search server 40 may obtain as search results modeled representations of items stored in database 50, along with ranking and/or query-specific information about the listed items, and send the search results to search interface server 20. Search interface server 20 may receive from search server 40, along with the search results, information about attributes and/or values of the items and/or the resulting ranking, according to attributes and/or values indicated in the interpreted search query. For example, in response to the query “light laptop”, search interface server 20 may receive a list of laptop items included in database 50, along with their respective weight values and ranked according to the respective weight values.

As indicated in block 140, search interface server 20 may analyze by at least one hardware processor 22 the results received from search server 40 and produce a design for GUI 500 accordingly. The design may be produced by adapting to the search results predefined designed elements stored in a design database 28, and/or adding the adapted elements to GUI 500. The analysis may include, for example, extraction of ranking and/or query-related information from the results, identification of the filters that were applied and/or extraction of statistical information, such as a quantity and/or percentage of items filtered out and/or left in the results list by each of the applied filters, for example relative to the entire target database and/or to a specific category.

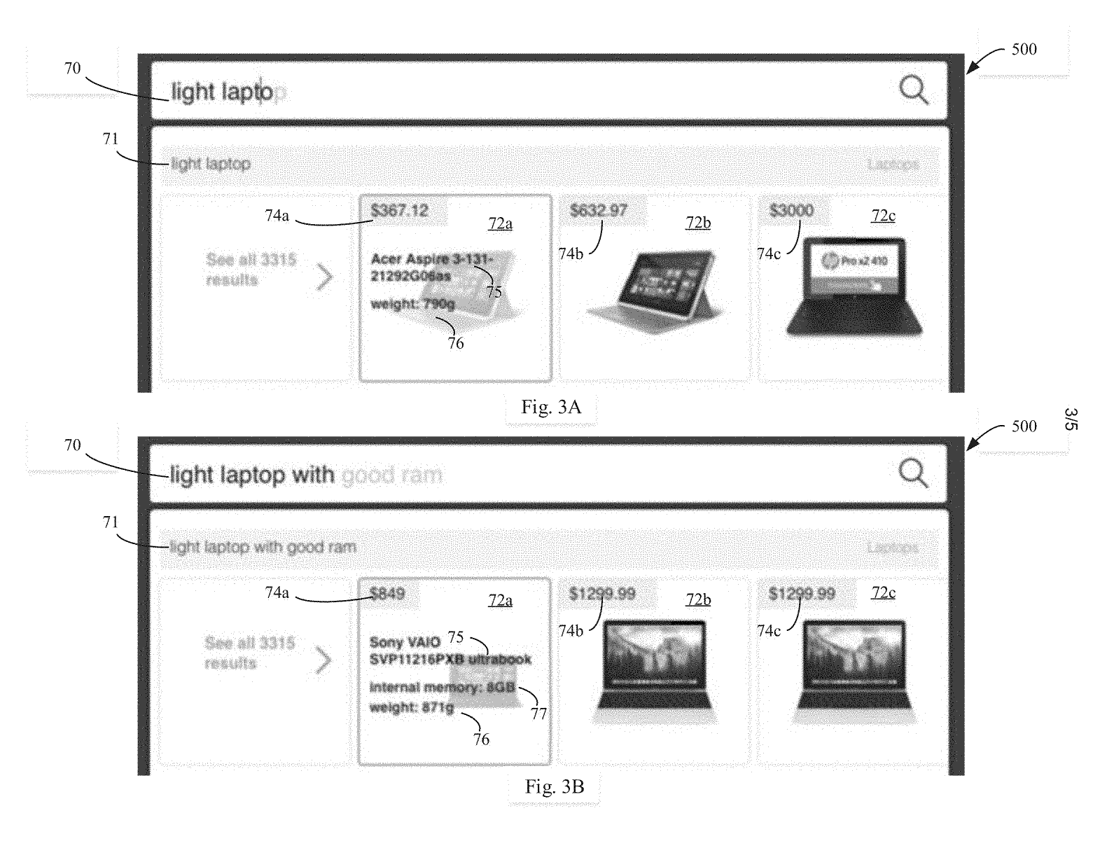

Accordingly, in some embodiments, GUI 500 is designed to display search results along with information about each of the items that is particularly relevant to the search query. As indicated in block 150, search interface server 20 may update GUI 500 according to the produced design. Some examples of GUI 500 are shown in FIGS. 3A, 3B and FIGS. 4-6.

Reference is now made to FIGS. 3A and 3B, which are schematic illustrations of a portion of a dynamically changing GUI 500, according to some embodiments of the present invention. GUI 500 includes a query field 70, in which a user may enter a search query. In the example of FIGS. 3A and 3B, GUI 500 includes a query field 70, current search terms field 71 and search results 72a-72c. GUI 500 may be updated upon any change in the search query and/or every pre-determined period of time. This way, it may be shown to a user how an addition, subtraction, or change of a term in the search query impacts the amount of items available in the database that suits the search query, and/or the information provided.

For example, in FIG. 3A, in response to the search terms “light laptop”, GUI 500 presents search results 72a-72c, e.g. laptop items extracted from database 50. As described herein, GUI 500 is designed to display search results 72a-72c along with accompanying information about each of the items that is particularly relevant to the search query, e.g. the weight 76 of each of the search results. In some embodiments, the design of GUI 500 may include showing the accompanying information in the vicinity of the search result, for example when the search result is selected and/or indicated by a mouse, keyboard, touch and/or any other selection and/or indication method. The accompanying information may also include other data as preconfigured in the GUI design, for example price 74a-74c and/or name, manufacturer and/or model 75 of the item.

When a user adds to the query “light laptop” the terms “with good ram”, as shown in FIG. 3B, NLA 32 may interpret the additional terms as an additional ranking parameter, i.e. ranking according to the internal memory value. Search server 40 may re-rank the laptop items according to two parameters, weight and internal memory, wherein the ranking is higher as the weight is lower and as the internal memory is larger. Then, GUI 500 may be updated according to the change in the search query. For example, the order in which the search results are presented may be changed according to the renewed ranking. Additionally, search results 72a-72c may be presented along with additional or changed accompanying information relevant to the updated search query, e.g. an internal memory value 77 of each of the search results. This way, it may be shown to a user how an addition, subtraction, or change of a term in the search query impacts the provided information, the order and/or the amount of items available in database 50 that suit the search query.

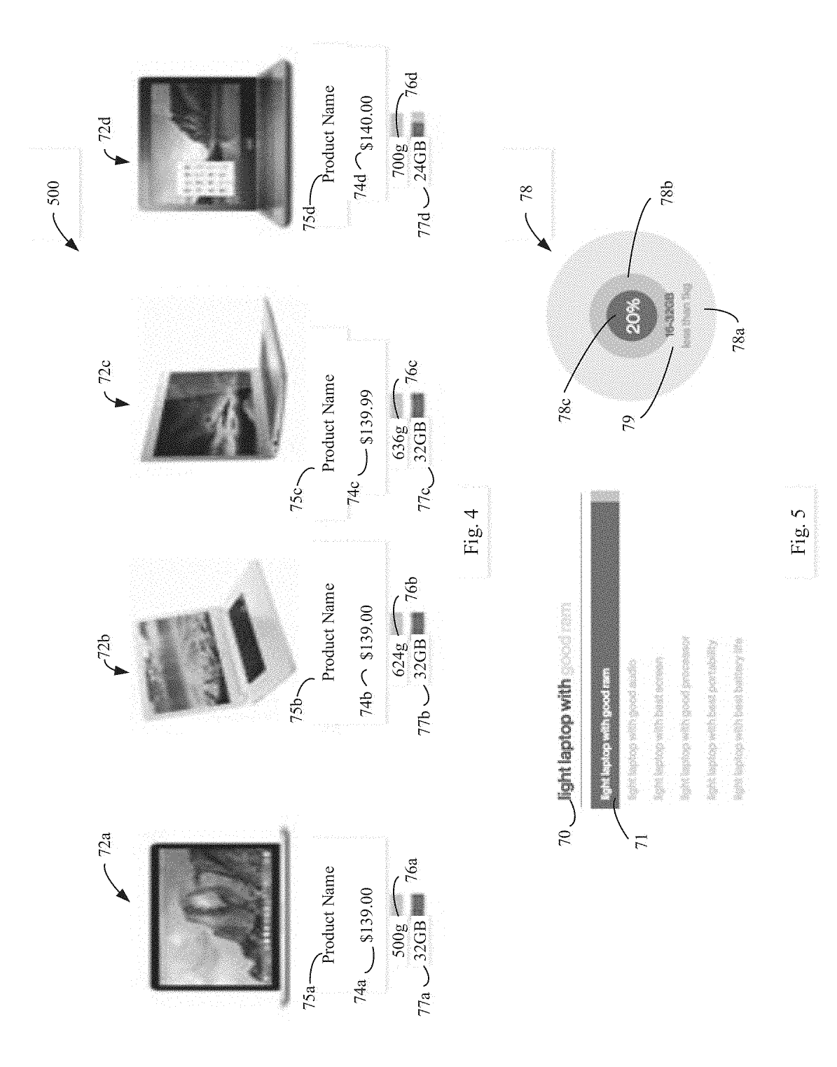

Another schematic illustration of an exemplary design of GUI 500 is shown in FIG. 4, in which search results 72a-72d are shown along with respective weight values 76a-76d and respective internal memory values 77a-77d, according to the interpretation of the query “light laptop with good ram”. Additionally, in this design of GUI 500 the respective prices 74a-74d and product names 75a-75d are also shown.

Therefore, according to the extracted query-related information, GUI 500 may be designed to display search results sorted in an order according to a certain parameter and/or an attribute indicated in the interpreted search query, and along with item information related to the parameters and/or attributes indicated in the interpreted search query. When the search query changes, the search results' order and/or the displayed information may change dynamically, for example in real time and/or in pre-defined periods.

Additionally or alternatively, GUI 500 may be designed to display statistical information about the group of search results, such as, for example, the size of the group relative to the entire database. For example, reference is now made to FIG. 5, which is a schematic illustration of a portion of dynamically changing GUI 500, according to some embodiments of the present invention, including an example of a statistical information graphic element 78.

For example, NLA 32 may interpret the term “light” in the search query “light laptop with good ram” as a filtering parameter for filtering out search results with weight values above a predefined threshold, for example above 1 kilogram. For example, NLA 32 may interpret the term “good ram” as a filtering parameter for filtering out search results with internal memory values below a predefined threshold, for example below 16 gigabytes. Based on the interpretation, search server 40 may filter the “laptop” category items according to the predefined thresholds and extract a result list, including items of the “laptop” category with light weight, for example below 1 kilogram, and with large internal memory, for example above 16 gigabytes. Additionally or alternatively, search server 40 may rank the results according to the parameter values, for example a higher rank as the weight is lower and as the internal memory is larger.

Search interface server 20 may analyze by at least one processor 22 the results received from search server 40, including extraction of ranking and/or query-related information from the results, identification of the filters that were applied and/or extraction of statistical information, such as a quantity and/or percentage of items filtered out and/or left in the results list by each of the applied filters, for example relative to the entire target database and/or to a specific category. Based on the analysis, search interface server 20 may produce a design for GUI 500 that may include statistical information about the target database and categories to which the listed items belong, and/or statistical information about attributes and values of each of the listed items, for example according to attributes mentioned in the search query or relate to it.

Accordingly, statistical information graphic element 78 may include representative shapes, each showing a size of a group of items or search results. For example, graphic element 78 includes representative graphic sub-elements 78a, 78b and 78c. For example, graphic sub-elements 78a, 78b and 78c may include circles or other shapes of different sizes, the smaller circles are contained in the larger circles, representing sizes of respective groups of items, i.e. the number of items in each group. For example, graphic sub-element 78a may represent the size of the group of all items included in the category “laptop”. Graphic sub-element 78b may represent the size of the group of all items included in the category “laptop” and that are lighter than 1 kilogram, i.e. the “laptop” category filtered by the query term “light”. Graphic sub-element 78c may represent the size of the group of all items included in the category “laptop”, which are lighter than 1 kilogram, and which have an internal memory larger than 16 gigabytes, i.e. the “laptop” category filtered by the query terms “light” and “good ram”.

Graphic element 78 may also include a text indication 79, which may include the sizes of the groups represented by graphic sub-elements 78a, 78b and/or 78c in number of items or in percentage, and/or indication of the meaning of each of graphic sub-elements 78a, 78b and/or 78c and/or what group they represent. When the search query changes, the number, shapes and/or sizes of the representative shapes may change accordingly, for example in real time or in predefined periods. For example, new representative shapes may be added and/or other representative shapes may be omitted, according to the filters identified in the search query by NLA 32.

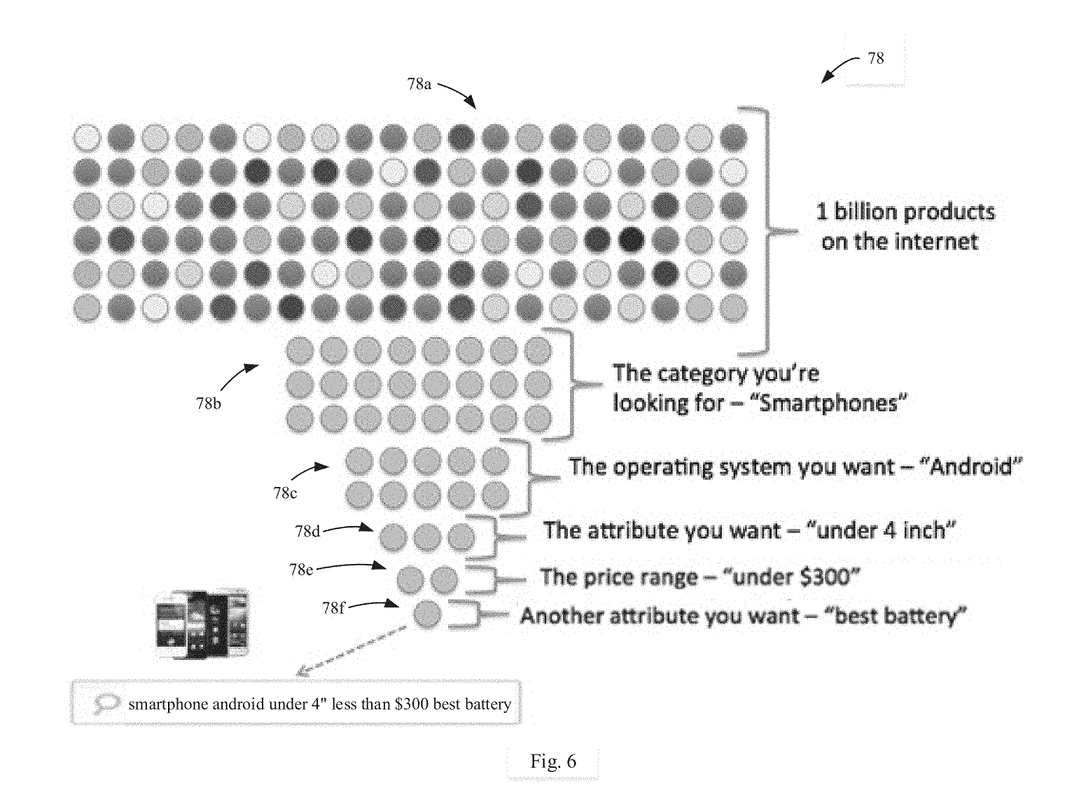

Reference is now made to FIG. 6, which is a schematic illustration of a portion of dynamically changing GUI 500, according to some embodiments of the present invention, including another example of a statistical information graphic element 78.

For example, a search query may recite “smartphone android under 4″ less than $300 best battery”. In this case, each of representative graphic sub-elements 78a-78f includes one or more units, for example circle units or units of any other suitable shape, wherein the number of units represents the number of items in the represented group. For example, each unit may represent 10, 100 or 1000 items. For example, graphic sub-element 78a represents the size of the group of all items included in database 50. Graphic sub-element 78b represents, for example, the size of the group of all items included in the category “smartphone”. Graphic sub-element 78c represents, for example, the size of the group of all items included in the category “smartphone” having an Android operating system.

Graphic sub-element 78d represents, for example, the size of the group of all items included in the category “smartphone” having an Android operating system and that their screen size is less than 4 inches. Graphic sub-element 78e may represent the size of the group of all items included in the category “smartphone” having an Android operating system that their screen size is less than 4 inches, which cost less than $300. Graphic sub-element 78f may represent the size of the group of all items included in the category “smartphone” having an Android operating system that their screen size is less than 4 inches, which cost less than $300, and which have the best battery in this category and with these attributes, i.e. the “smartphone” category filtered by the query terms “android under 4″ less than $300 best battery”. The term “best battery” may be interpreted by NLA 32, for example, as a filter for filtering out items having a battery with lifetime shorter than a predetermined threshold or than the best battery lifetime in the relevant group of items.

In some embodiments of the present invention, upon every change in a search query input, for example whenever a user types into a query field, a request for an update is sent to interface server 20 and/or search server 40. Search server 40 returns search results and GUI 500 displays them on client machine 60.

In some cases, for example when client machine 60 has enough computational power and/or not much memory is needed, Search server 40 may send relevant data from indexed database 50, such as all items belonging to a relevant category. In such embodiments, some or all of the operations attributed to search server 40 as described in detail herein may be performed by GUI 500 and/or interface server 20, for example at client machine 60. In this case, the experience can be much faster and feel smoother. For example, search server 40 may identify that the user is looking for a smartphone, for example by any of the methods described above, and send the entire indexed data relevant to the smartphone category from database 50 to client machine 60. Accordingly, in some embodiments of the present invention, GUI 500 may execute logic on client machine 60 that may perform in the relevant indexed data some or all of the search operations that are attributed search server 40 herein.

In some embodiments of the present invention, search results are stored in a cache memory. For example, GUI 500 may delay re-computation and/or extraction of search results in cases when a change in the search query does not require an update of the search results. For example, in cases when a user deletes a word and/or a letter re-computation of the search results may not be required. In some embodiments of the present invention, server 40 and/or GUI 500 updates the search only when new information is added to the query, for example after a predetermined period of time from the previous update and/or by requiring a space from a previous search term in order to count a query change as new information.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for controlling a graphical user interface (GUI) configured for searching in a database and for changing dynamically based on a received search query, the system comprising:
a memory storing a code; and
at least one hardware processor coupled to the memory for executing said code, the code comprising:
instructions for maintaining a database indexed according to attributes defined in a database model;
instructions for interpreting a received search query term by a natural language analyzer as at least one of the attributes;
instructions for extracting from the indexed database search results having values of the at least one of the attributes; and
instructions for adapting design elements of the GUI to display statistical information about the used at least one attribute and the attribute values.

2. The system of claim 1, wherein the code comprises instructions for using the at least one of the attributes as a sorting parameter for use by the search server for sorting query results.

3. The system of claim 1, wherein the code comprises instructions for interpreting a received search query term as at least one of a category, an attribute or an attribute value of the database model.

4. The system of claim 1, wherein the code comprises instructions for using the at least one of the attributes as a filtering parameter for filtering out search results with values that cross a predefined threshold.

5. The system of claim 1, wherein the code comprises instructions for obtaining from the indexed database information about at least one of a category, attribute and value of each search result, based on the interpretation of the search term.

6. The system of claim 5, wherein the code comprises instructions for updating the design of the GUI to present in the vicinity of each search result the obtained information.

7. The system of claim 6, wherein the code comprises instructions for updating the design of the GUI to present the search results in an order according to ranking scores assigned to each search result according to a value of the at least one of the attributes.

8. The system of claim 1, wherein adapting design elements of the GUI is to display ranking of the search results according to values of the at least one of the attributes.

9. The system of claim 1, wherein the statistical information includes a size of a group of items included in the search results relative to a size of the indexed database and a size of a specific category of the indexed database.

10. The system of claim 1, wherein the code comprises instructions for identifying filters applied by the search server.

11. The system of claim 1, wherein the code comprises instructions for updating the design of the GUI by adapting to the search results predefined designed elements stored in a design database and adding the adapted elements to the GUI.

12. The system of claim 1, wherein the code comprises instructions for updating the design of the GUI in real time upon a change in the search query or in pre-determined time periods.

13. The system of claim 1, wherein the code comprises instructions for updating the design of the GUI by changing in response to a change in the search query at least one of an order the search results, information accompanying the search results, or a graphical element representing the group of items included in the search results.

14. The system of claim 13, wherein the graphical element comprises at least one representative graphic sub-element representing a size of a group of search results relative to a size of another group of search results.

15. The system of claim 14, wherein the graphical element comprises at least two representative graphic sub-element having shapes of different sizes, the smaller shapes are contained in the larger shapes, representing sizes of respective groups of items.

16. The system of claim 15, wherein each of representative graphic sub-elements includes one or more units, wherein the number of units represents the number of items in the represented group.

17. A method for controlling a graphical user interface (GUI) configured for searching in a database and for changing dynamically based on a received search query, the method comprising:
maintaining a database indexed according to attributes defined in a database model;
interpreting a received search query term by a natural language analyzer as at least one of the attributes;
extracting from the indexed database search results having values of the at least one of the attributes; and
adapting design elements of the GUI to display statistical information about the used at least one attribute and the attribute values.
